(19) United States
(12) Patent Application Publication
(10) Pub. No.: US 2026/0085750 A1
(43) Pub. Date: Mar. 26, 2026

(54) RESIN MOLDED GEAR

(71) Applicants: PLALINK CO., LTD., Aichi (JP); NICHIEI CO., LTD., Aichi (JP)

(72) Inventors: Yusuke SUGIURA, Aichi (JP); Masahiko YAMAKI, Aichi (JP)

(21) Appl. No.: 18/992,135

(22) PCT Filed: Jul. 3, 2023
(86) PCT No.: PCT/JP2023/024570

§ 371 Date: Dec. 12, 2025

(30) Foreign Application Priority Data
Jul. 7, 2022 (JP) 2022-109718

(51) Int. Cl. F16H 55/06; B29C 45/00; B29C 45/14; B29L 15/00; F16H 55/17

(52) U.S. Cl. CPC F16H 55/06; B29C 45/0005; B29C 45/0046; B29C 45/14344; F16H 55/17; B29L 2015/003; F16H 2055/065

(57) ABSTRACT

To align the orientation of resin fibers of a resin molded gear produced by insert molding and suppress the manufacturing cost of the resin molded gear.

The present invention includes a resin molded gear 1 and a gear-shaped insert 2. The insert 2 includes a web portion 21 and tooth portions 22. Each tooth portion 22 has tooth bottom portions 22a that oppose the tooth bottoms 12a of the resin molded gear 1 and a tooth tip portion 22c that opposes a tooth tip 12c of the resin molded gear 1. An annular first flow path 23 is formed in the surface of the web portion 21, and outlets 23a are provided on the outer edge of the first flow path 23 to allow molten resin 31 to flow out to the tooth bottom portions 22a.

### TECHNICAL FIELD

The present disclosure relates to a resin molded gear produced by insert molding.

### BACKGROUND

Conventionally, insert molding technology has been known to provide resin molded gears, whereby an insert member is placed into a mold and molten resin is injected into a cavity formed between the insert member and the mold for resin molding. For example, Patent Document 1 proposes a technology that prevents the formation of weld lines on the tooth surfaces and increases the durability of gears by providing guiding paths for molten resin in the insert and using the guiding paths to guide the molten resin to the portions corresponding to the tooth bottom surfaces. In addition, Patent Document 2 proposes a resin molded gear in which flow channels are formed to guide molten resin injected into a gear-shaped insert through the insert member to tooth portions, and the open ends of the flow channels are provided at the tooth bottoms of the tooth portions. Patent Document 3 proposes a technology that suppresses the retention of molten resin and suppresses resin cracking and peeling of the molded product by pretreating the surface of the insert and heating the insert.

### CITATION LIST

### Patent Documents

Patent Document 1: JP 2009-154463A

Patent Document 2: International Publication No. WO 2021/049533

Patent Document 3: International Publication No. WO 2005/046957

### SUMMARY OF INVENTION

### Technical Problem

To ensure the strength of a resin molded gear, it is desirable to use fiber-reinforced resin, and the fiber orientations of the resin part coating the tooth surfaces should be aligned along the tooth surfaces. It is preferable that weld lines of the resin should not be formed on the tooth profiles, but should be formed outside the tooth surfaces where no contact friction occurs due to gear power transmission. In resin gears molded with metal gear inserts, the strengths of the dedendums are reinforced by the metal inserts, so that the durability of the gears is not an issue. However, the frictional wear of the resin on the tooth surfaces greatly affects the durability of the gears. From this point of view, fiber-reinforced resins, made by blending super engineering plastics that have excellent friction and wear characteristics with carbon fiber or other materials, are preferred. However, such resins are extremely expensive, and cost has been a major issue in their practical application. In this regard, the technologies of Patent Documents 1 and 2 have the problems that the flow paths of molten resin are complicated, which increases the manufacturing cost of the inserts, and that the amount of molten resin used increases, which in turn increases the material cost. The technology described in Patent Document 3 suffers from the problem that it takes a long time to control temperature.

Therefore, the object of the present disclosure is to provide a resin molded gear in which the fibers can be oriented from the tooth bottoms to the tooth tips, and the weld lines can be formed to coincide with the centerlines of the tooth tips, and the flow paths of molten resin formed in the insert are simplified.

### Solution to Problem

In order to solve the above-described problem, a resin molded gear of the present disclosure includes the following characteristics:
(1) A resin molded gear produced by insert molding includes the resin molded gear and a gear-shaped insert, wherein the insert includes a web portion, tooth portions, and a flow path for allowing molten resin to flow to the web portion or the tooth portions, wherein the tooth portions include tooth bottom portions that oppose tooth bottoms of the resin molded gear and tooth tip portions that oppose tooth tips of the resin molded gear, and wherein an annular first flow path is formed in a surface of the web portion, and outlets are provided on an outer edge of the first flow path, the outlets allowing molten resin to flow to the tooth bottom portions.
(2) In the resin molded gear described in (1), the insert is a metallic material.
(3) In the resin molded gear described in (1) or (2), a resin part coating the insert is a fiber-reinforced resin.

### Advantageous Effects of Invention

According to the resin molded gear of the present disclosure, the outlets are provided on the outer edge of the first flow path to allow the molten resin to flow directly to the tooth bottom portions. Consequently, the molten resin flowing from the first flow path to the tooth bottom portions flows along the tooth surface portions within the cavity to coalesce at the centerlines at the tooth tip portions. Therefore, the fiber orientation is arranged from the tooth bottoms of the gear teeth toward the tooth tips, forming weld lines along the centerlines at the tooth tips of the gear teeth. Moreover, the provision of the outlets on the outer edge of the first flow path simplifies the flow path to reduce the amount of molten resin and also suppress the manufacturing cost of the insert itself. In addition, because the metal insert can suppress resin shrinkage, a high-precision resin gear can be produced with the precision of the mold for the resin tooth profile. Accordingly, as the metal insert itself does not require the precision required for metal gears, the manufacturing costs can also be reduced.

### BRIEF DESCRIPTION OF DRAWINGS

FIG. 1(a) is a plan view of a resin molded gear showing one embodiment of the present disclosure, and FIG. 1(b) is a bottom view thereof.

FIG. 2(a) is a perspective view of the resin molded gear of FIG. 1 as seen from the plan view side, and FIG. 2(b) is a perspective view thereof as seen from the bottom view side.

FIG. 3(a) is a plan view of an insert, and FIG. 3(b) is a bottom view thereof.

FIG. 4(a) is a perspective view of the insert as seen from the plan view side, and FIG. 4(b) is a perspective view thereof as seen from the bottom view side.

FIG. 5(a) is a cross-sectional view taken along line A-A, and FIG. 5(b) is a cross-sectional view taken along line B-B.

FIG. 6 is a schematic diagram showing a method of manufacturing the resin molded gear.

FIG. 7 is a schematic diagram showing fiber orientations and a weld line of the resin molded gear.

### DESCRIPTION OF EMBODIMENTS

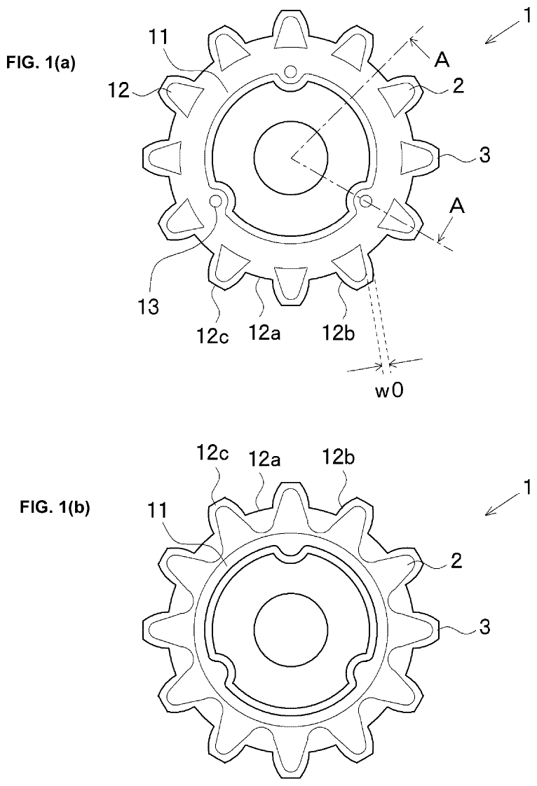

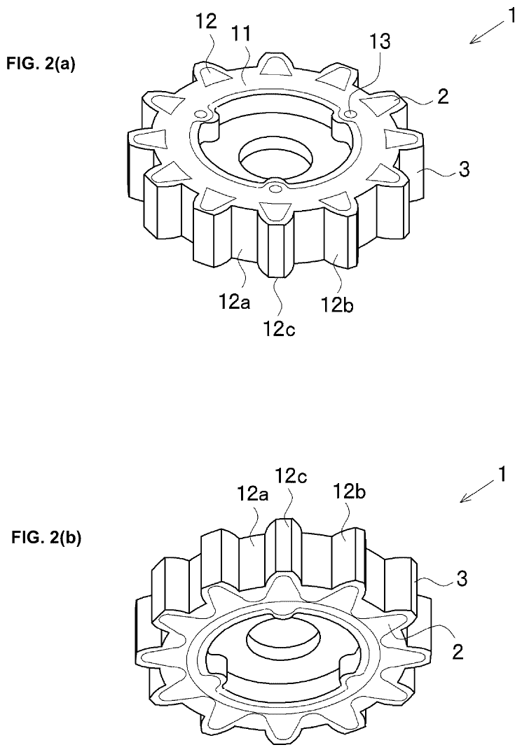

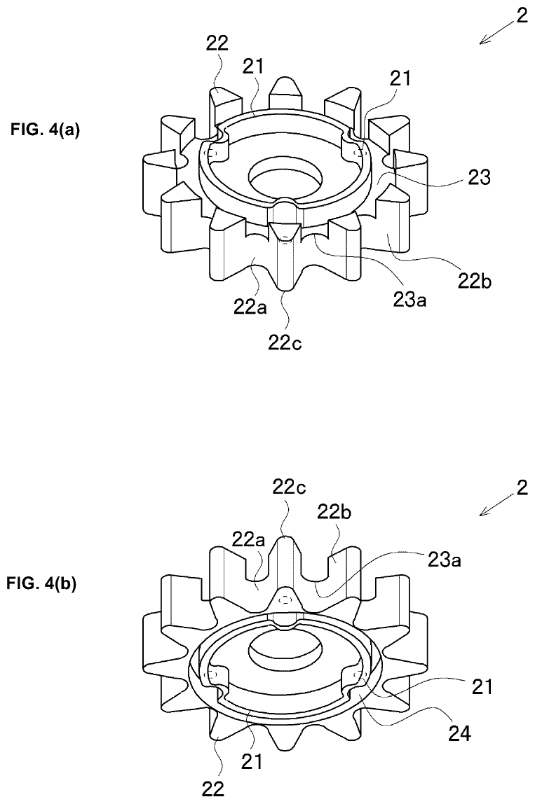

A resin molded gear that embodies the present disclosure will be described hereinafter with reference to the drawings. As shown in FIGS. 1-5, the resin molded gear 1 is a resin molded gear produced by insert molding. The resin molded gear 1 is comprised of an insert 2 and a resin member 3. The resin molded gear 1 also includes a web 11 and gear teeth 12. Each gear tooth 12 is comprised of tooth bottoms 12a, tooth surfaces 12b, and a tooth tip 12c. What is shown on the upper side of each drawing sheet will be referred to as the front face of the resin molded gear 1 and/or the insert 2, and what is shown on the lower side of each drawing sheet will be referred to as the back face of the resin molded gear 1 and/or the insert 2.

Insert molding refers to a manufacturing method in which molten resin 31 is injected between the mold 4 and insert 2. It should be noted that it is preferable to select a metallic material for the insert 2. This is because when the molten resin 31 is injected, deformation due to heat can be suppressed, so that the resin molded gear 1 can be molded with a high degree of accuracy that is closer to the designed dimensions. Furthermore, there are also advantages to applying a resin coating to provide a resin molded gear rather than forming the gear only from metal. This is because resin is quieter during operation than metal, and therefore, when the gear teeth are coated with resin, operational noise can be suppressed.

The material for the insert 2 can specifically be selected from metals such as aluminum alloys, magnesium alloys, iron alloys, and resins such as thermoplastic resins and thermosetting resins. The insert 2 is formed by sintering, metal injection molding (MIM: Metal Injection Molding), forging, or press forming. In particular, the insert 2, if formed by MIM, excels in design freedom and economic efficiency of the insert 2.

Specifically, synthetic resin materials can be used for the resin member 3, such as polyetheretherketone (PEEK), polyamideimide (PAI), polyimide (PI), polyethersulfone (PES), liquid crystal polymer (LCP), polyphenylene sulfide (PPS), polyphthalamide (PPA), polyarylate (PAR), polybutylene terephthalate (PBT), polyethylene terephthalate (PET), polytetramethylene adipamide (PA46), polyhexamethylene adipamide (PA66), polynonamethylene terephthalamide (PA9T), polydecamethylene terephthalamide (PA10T), polydodecamethylene terephthalamide (PA12T), among others. The resin member 3 can be reinforced with carbon fiber, glass fiber, aramid fiber, among others, and lubricants such as polytetrafluoroethylene (PTFE) and other fluoropolymers, silicone resin, molybdenum disulfide, graphite, among others, can be blended to impart friction properties.

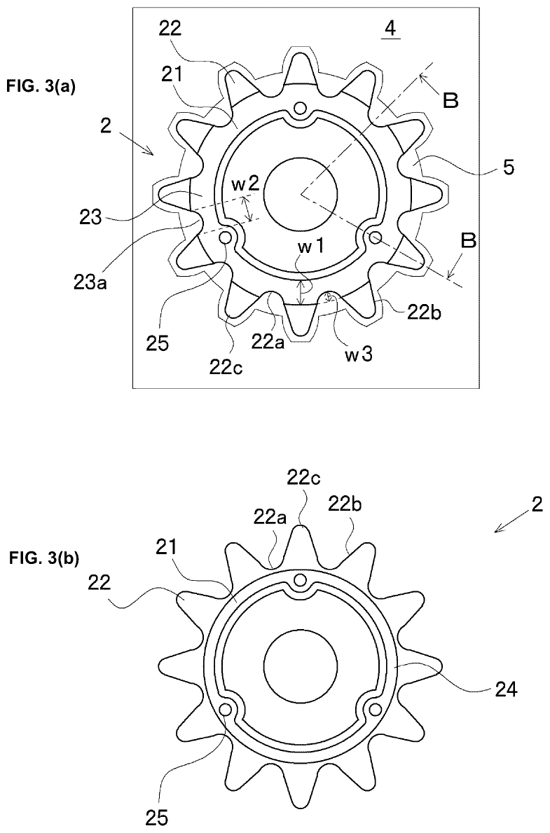

As shown in FIGS. 3-5, the insert 2 is provided in a gear shape approximately analogous to the shape of the resin molded gear 1 and comprised of a web portion 21 and tooth portions 22. The tooth portions 22 each have tooth bottom portions 22a that oppose the tooth bottoms 12a of the resin molded gear 1, tooth surface portions 22b that oppose the tooth surfaces 12b of the resin molded gear 1, and a tooth tip portion 22c that opposes a tooth tip 12c of the resin molded gear 1.

A first flow path 23 is annularly formed in the front face of the web portion 21, and outlets 23a are provided on the outer edge of the first flow path 23 to allow molten resin 31 to flow out to the tooth bottom portions 22a. The flow path width w1 of the first flow path 23 can be selected as appropriate, but it is preferable to provide a narrower channel to suppress the amount of molten resin 31.

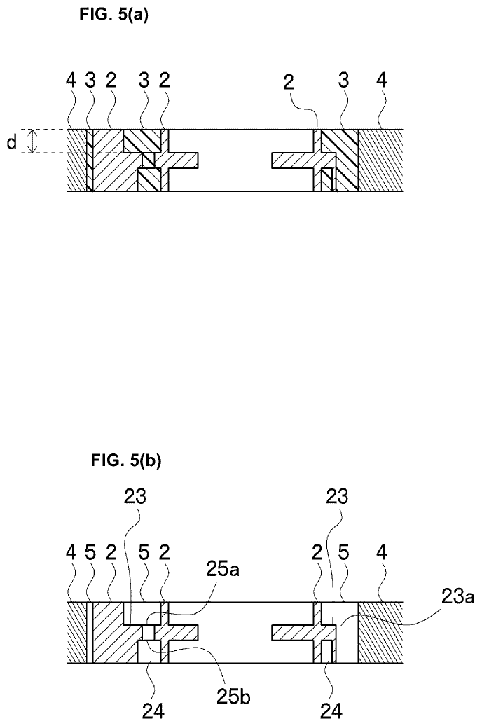

A second flow path 24 is formed annularly in the back face of the web section 21. The web portion 21 is also provided with through-holes 25 that penetrate the web portion 21 from the front face of the web portion 21 to the back face thereof. An opening 25a of each through-hole 25 is located in the first flow path 23, and an opening 25b is located in the second flow path 24 (see FIG. 5). Because the through-holes 25 and the second flow path 24 are provided, when the resin member 3 filled in the through-holes 25 and the second flow path 24 hardens, it is possible to prevent the insert 2 from falling out of the resin molded gear 1. It should be noted that injection ports 13 of the molten resin 31 should be preferably positioned vertically above the openings 25a. The number of the injection ports 13 can be changed as needed.

In this case, the depth d of the first flow path 23 (see FIG. 5), the flow path width w1 of the first flow path 23, the width w2 of the outlets 23a, and the recess width w3 of the outlets 23a (see FIG. 3) are formed to be greater than the thickness w0 (see FIG. 1) of the resin member 3 coated on the tooth surface portions 22b, that is, “d>w0, w1>w0, w2>w0, and w3>w0. Since d, w1, w2, and w3 of the first flow path 23 are made greater than the thickness w0 of the resin member 3 coated on the tooth surfaces 12b, the arrival time differences of the molten resin 31 reaching the tooth bottoms 22a can be made smaller. Therefore, resin welding can be prevented from occurring on the tooth surfaces 12b of each gear tooth 12. In other words, the flow balance of the molten resin 32 on the tooth surface portions 22b can be adjusted to be uniform to reliably form a weld line 33 at the tooth tip 12c of each gear tooth 12.

The flow path width w1 of the first flow path 23 is formed to be greater than the width w3 of the outlets 23, i.e., “w1>w3”. Therefore, the circumferential flow of the molten resin 3 is prioritized and the delay of the molten resin 3 reaching the gear teeth 12 far from the injection ports 13 can be reduced to make the quality of the gear teeth 12 more uniform. Additionally, the recess width W3 of the outlet 23 can be less than or equal to one half of the flow path width w1. In this case, the circumferential flow of the molten resin 3 is also prioritized so as to reduce the delay of the molten resin 31 reaching the gear teeth 12 far from the injection ports 13, resulting in a more uniform quality of the gear teeth 12.

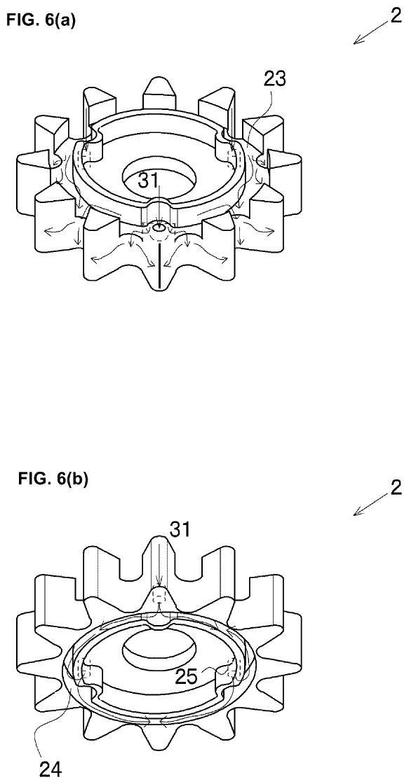

The method of manufacturing the resin molded gear 1 with the above configuration will now be described with reference to FIG. 6. When molten resin 31 is injected into the injection ports 13, the molten resin 31 flows circumferentially along the first flow path 23 and enters the tooth bottom portions 22a from the outlets 23a of the first flow path 23. The molten resin 31 entering the tooth bottom portions 22a flows along the tooth bottom portions 22a in the thickness direction of the insert 2. At the same time, the molten resin 31 also flows through the cavity 5 to form the gear teeth 12, creeping along the tooth surface portions 22b from the tooth bottom portions 22a toward the tooth tip portions 22c.

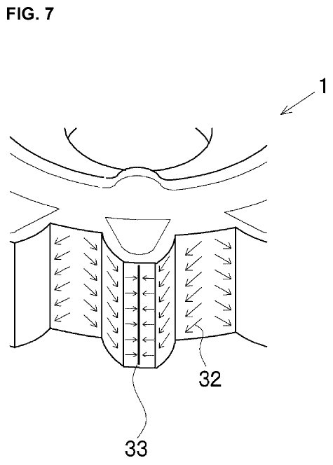

Subsequently, once the molten resin 31 hardens, as shown in FIG. 7, the resin member 3 is formed that includes resin fibers 32 with fibers orientated in the flow directions of the molten resin 31, that is, from the tooth bottom 12a to the tooth tip 12c. In addition, a weld line 33 is formed to coincide with the centerline of the tooth tip 12c.

Meanwhile, the molten resin 31 injected via the injection ports 13 flows through the through-holes 25 from the openings 25a on the front face of the web portion 21 toward the back face, and then flows into the second flow path 24 from the openings 25b on the back face. The molten resin 31 flowing into the second flow path 24 flows circumferentially along the back face of the insert 2 through the second flow path 24. Subsequently, when the molten resin 31 hardens, the resin member 3, which penetrating the interior of the resin molded gear 1 and annularly formed on the back face of the resin molded gear 1, can prevent the insert 2 from falling out.

Therefore, according to the resin molded gear 1 of the present disclosure, the provision of the outlets 23a on the outer edge of the first flow path 23 allows the molten resin 31 to flow directly onto the tooth bottom portions 22a. Consequently, the molten resin 31 flowing through the first flow path 23 can be directed from the tooth bottoms 12a towards the tooth tips 12c within the cavity. This ensures that the resin orientations are arraigned from the tooth bottoms 12a to the tooth tips 12c. Furthermore, since the insert 2 is simply structured with the outlets 23a formed on the outer edge of the first flow path 23 that allow molten resin 31 to flow out directly therefrom, the manufacturing cost of the insert 2 can be reduced, and the amount of molten resin 31 can be reduced to lower the material cost.

The present disclosure is not limited to the above-described embodiment, and to the extent not departing from the spirit of the present disclosure, the shape and configuration of each component can be changed as appropriate, for example, by changing the shape and number of teeth of the gear or the thickness of the resin member 3.

### LIST OF REFERENCE NUMERALS

1 Resin molded gear
2 Insert
3 Resin member
4 Mold
5 Cavity
11 Web
12 Gear tooth (a: tooth bottom, b: tooth surface, c: tooth tip)
13 Injection port
21 Web portion
22 Tooth portion (a: tooth bottom portion, b: tooth surface portion, c: tooth tip portion)
23 First flow path (a: outlet)
24 Second flow path
25 Through-hole (a: opening on front face, b: opening on back face)
31 Molten resin
32 Resin fiber
33 Weld line

1. A resin molded gear produced by insert molding, characterized by comprising:
a gear-shaped insert,
wherein the insert includes a web portion and one or more tooth portions;
wherein each of the one or more tooth portions includes tooth bottom portions that oppose tooth bottoms of the resin molded gear and tooth tip portions that oppose tooth tips of the resin molded gear;
wherein the web portion includes a first face with injection ports for molten resin formed thereon and a second face, the second face being a reverse face of the first face;
wherein an annular first flow path is formed in a surface of the first face, the first flow path allowing molten resin to flow therethrough;
wherein an outlets is provided on an outer edge of the first flow path, the outlets allowing molten resin to flow to each of the tooth bottoms; and
wherein the outlets are formed by making cutouts in the tooth bottom portions in a thickness direction of the insert from the first face and removing the tooth bottom portions on a side of the first face to a bottom of the first flow path.

2. The resin mold gear of claim 1, comprising one or more through-holes connecting the first flow path with the second surface via an interior of the web portion.

3. The resin mold gear of claim 2 comprising an annular second flow path formed in the second surface,
wherein the second flow path is connected to the first flow path via the one or more through-holes.

4. The resin mold gear of claim 1 comprising one or more tooth tips coated with a resin member formed by hardening of the molten resin,
wherein the resin member is a fiber-reinforced resin, and
wherein fibers of the fiber-reinforced resin are oriented toward the one or more tooth tips.
